(19) United States
(12) Patent Application Publication
(10) Pub. No.: US 2024/0051239 A1
(43) Pub. Date: Feb. 15, 2024

(54) Water-Dispersible Fabric

(71) Applicants: Ehud Giloh, Netanya (IL); Tamar Giloh, Netanya (IL)

(72) Inventors: Ehud Giloh, Netanya (IL); Tamar Giloh, Netanya (IL)

(21) Appl. No.: 18/260,854

(22) PCT Filed: Jan. 10, 2022
(86) PCT No.: PCT/IL2022/050034

§ 371 Date: Jul. 10, 2023

Related U.S. Application Data
(60) Provisional application No. 63/135,683, filed on Jan. 10, 2021.

(51) Int. Cl. B29C 70/12

(52) U.S. Cl. CPC B29C 70/12; B29L 2007/002

(57) ABSTRACT

Provided is a water-dispersible hybrid sheet comprising a water-soluble polymer, and short loose fibers. The water-soluble polymer acts as a binding agent for the loose fibers to bind to, thereby creating a fabric layer. When exposed to water or aqueous environment, the water-dispersible hybrid sheet disintegrates.

### TECHNICAL FIELD

The present disclosure generally relates to a water-dispersible hybrid sheet, and more specifically to a water-dispersible hybrid sheet comprising water-soluble polymers.

### BACKGROUND

Environmental pollution caused by the textile industry, for example, when producing clothing items, as well as disposable products, is becoming more severe during the recent decades. Prosperity on the one hand and cheap labor on the other hand drive excessive production, single use products and fast-changing fashion, that end up in landfills, as growing piles of textile waste that pollute soil and water.

Furthermore, many disposable products as well as some textiles currently comprise plastic ingredients, which may take hundreds of years to disintegrate. In addition, some disposable products, such as wet wipes, may accumulate and thus cause blockage and clogging along the sewage (draining) system.

There is therefore a need for eco-friendly fabrics, which would not accumulate as waste.

### SUMMARY

The present disclosure provides a water-dispersible hybrid sheet comprising a water-soluble polymer, and short loose fibers. In some embodiments, the water-soluble polymer may act as a binding agent for the loose fibers to bind within, thereby creating a continuous fabric layer. In some embodiments, when exposed to water or aqueous environment, the water-dispersible hybrid sheet may disintegrate into non-waste particles.

In some embodiments, the water-soluble polymer may create a water-soluble polymeric core layer having an upper side and a bottom side. In some embodiments, the loose fibers may be partly embedded into at least the upper side, the bottom side or both the upper and bottom sides of the water-soluble polymeric core layer.

In some embodiments, when the water-dispersible hybrid sheet is exposed to water or aqueous environment at predetermined conditions, the water-soluble polymeric core layer may begin to dissolve and the connection between the loose fibers and the water-soluble polymeric core layer may weaken until each of the loose fibers separately disconnects from the water-soluble polymeric core layer, to prevent creation of fiber chains or fiber agglomeration, thereby avoiding clogging.

In some embodiments, the loose fibers may be biodegradable fibers.

In some embodiments, the loose fibers may be hydrophilic, thereby detaching from the water-soluble polymeric core layer. In some embodiments, the hydrophilic loose fibers may be configured to absorb moisture or water from the environment to promote disintegration of the water-soluble polymeric core layer by leading water into the water-soluble polymeric core layer, at currently empty locations that the fibers used to occupy when the fibers were embedded into the water-soluble polymeric core layer.

In some embodiments, the loose fibers may be water-soluble.

In some embodiments, the water-soluble polymer may comprise a mixture of at least one water-soluble polymer and at least one biodegradable polymer.

In some embodiments, when the water-dispersible hybrid sheet is exposed to water or aqueous environment at predetermined conditions, the water-dispersible hybrid sheet may disintegrate into water-soluble pieces and biodegradable pieces, without any microplastics.

In some embodiments, thickness of the water-dispersible hybrid sheet may be between 0.1 to 3 mm.

In some embodiments, length of the loose fibres may be between 0.2 to 3 mm.

In some embodiments, the water-dispersible hybrid sheet may further comprise midway biodegradable fibers, to improve various properties of the water-dispersible hybrid sheet.

In some embodiments, substantially an entire length of the midway fibers is positioned within the water-soluble polymeric core layer.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a cross-section of a water-dispersible hybrid sheet prior to its exposure to water or to an aqueous solution, according to some embodiments of the present disclosure;

FIG. 2 is a schematic illustration of a cross-section of a water-dispersible hybrid sheet, a short time after being exposed to water or to an aqueous solution, according to some embodiments of the present disclosure; and

FIG. 3 is a schematic illustration of a water-dispersible hybrid sheet, at a late time after being exposed to water or to an aqueous solution, according to some embodiments of the present disclosure.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

The present disclosure aims to reduce the problem of textile and disposables' pollution by providing an eco-friendly fabric that quickly disperses in water without causing any clogging. The present disclosure provides environmentally safe and eco-friendly alternative fabrics, by using water soluble polymers as a core structure of such fabrics.

Attempts to create products, mostly for personal care, e.g., disposable sanitary pads, by using water dissolving polymers are known in the art, mostly based on nonwoven technologies. However, even the numerous products that made their way to the shelves fail to meet the goal of quick disperse in water without causing pollution and creating clogging issues, due to the nonwoven technology, which during its disintegration process creates long slow dissolving fabrics.

Accordingly, the present disclosure provides water-dispersible hybrid sheets, e.g., fabric(s), garment(s) and other products, made from combinations of water-soluble polymer(s) and fully biodegradable, short, discrete fibers that easily and quickly dissolve in water or aqueous solutions without leaving any remainders that may be considered as waste.

According to the present disclosure, the water-soluble polymers create the core structure comprising an uneven arrangement with integrated air tunnels, and the fibers are individually, directly joint into the water-soluble polymeric layer. The water-soluble polymers may act as a bonding agent for the loose fibers, to thereby create a continuous fabric layer. In some embodiments, the water-soluble polymers create the core layer into which the loose fivers are partly embedded, either on one side of the core layer or on both sides of the core layer, as will be explained hereinbelow. Based on this unique structure, the dispersing phase begins when the water-dispersible hybrid sheet is placed in water, e.g., tap water, or in an aqueous solution. During the dispersing phase, the fibers quickly disintegrate within a few minutes to a few hours from the eco-friendly water-dispersible hybrid sheet, promoting quick fabric dispersion in aqueous environment or water with different temperature levels. Typically, the temperature of the water or aqueous environment that is suitable for disintegration of the water-dispersible hybrid sheet, may be between 15 to 65 degrees Celsius, depending on water soluble grade and specifications of the polymers and fibers that the water-dispersible hybrid sheet is comprised of. In some embodiments, the loose fibers may also be water-soluble, thereby, the fast-dispersing eco-friendly fabric leaves no harmful pollution or remains after its dispersion.

The phrase “loose fibers” refers to any suitable loose flocking fiber material.

The terms “water-soluble polymeric layer”, “polymeric layer”, “polymeric core”, “polymeric continuous layer”, “water-soluble polymeric core layer”, and “water-soluble polymeric core”, are interchangeable throughout the disclosure. Although referred to as “continuous”, in some embodiments, the water-soluble polymeric layer may be perforated.

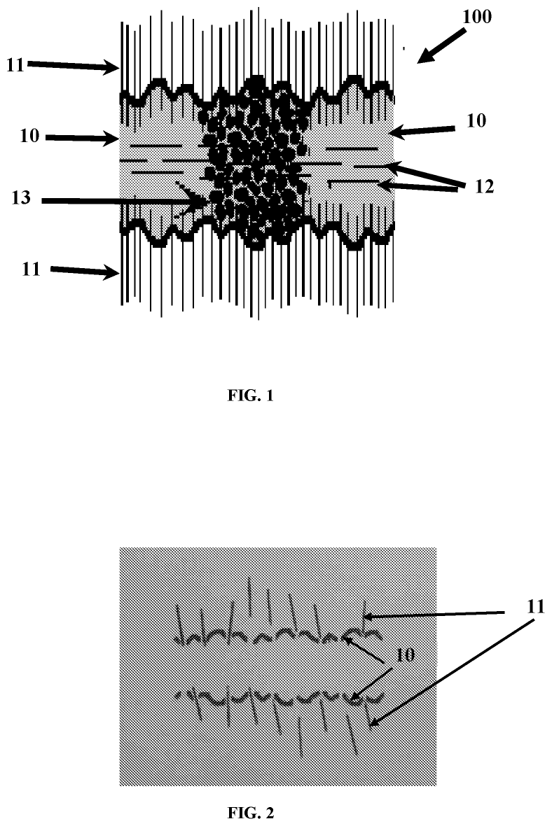

According to embodiments of the present disclosure, there is provided a water-dispersible hybrid sheet that is capable of completely dispersing in water, for example, after it reaches its ‘end of life’, e.g., when there is no further use for the fabric or garment. Reference is now made to FIG. 1, which schematically illustrates the water-dispersible hybrid sheet prior to its exposure to water or an aqueous solution, according to some embodiments of the present disclosure. According to some embodiments, the water-dispersible hybrid sheet 100 may comprise a middle core of a single, continuous polymeric layer 10, made of water-soluble polymers. In some embodiments, the polymeric layer may be structured as an un-even structure with built-in air ways and/or pores 13. In some embodiments, the water-soluble polymeric layer 10 may have a thickness of between 0.1 mm to 3 mm. In some embodiments, the water-soluble polymeric layer 10 may have a thickness of up to 10 mm. In some embodiments, the water-dispersible hybrid sheet 100 may further comprise a plurality of short, separate, biodegradable fibers 11. In some embodiments, fibers 11 may be directly attached to the water-soluble polymeric core layer 10, whereby each of fibers 11 may comprise a first end and a second end, and each of the fiber's first end may be individually implanted, without an addition of a binder, into the water-soluble polymeric layer 10, while the second, e.g., opposite, end may be exposed to air and may be protruding out of the water-soluble polymeric layer 10 to provide a textile-like feeling. In some embodiments, the fibers' length may range between approximately 0.2 mm to 3 mm. In some embodiments, fibers 11 may be water-soluble as is the polymeric core.

In some embodiments, the fibers 11 may be partly embedded into the polymeric layer 10, such that some fibers 11 are partly embedded (embedded only via one end of each fiber 11, as explained hereinabove) into and along one side of the polymeric layer 10, e.g., an upper side of the polymeric layer. In other embodiments, some of fibers 11 may be partly embedded into and along a second different side, e.g., a lower side, of the polymeric layer 10. And in yet other embodiments, fibers 11 may be partly embedded into and along both sides of polymeric layer 10.

In some embodiments, water-soluble polymeric core layer 10 may comprise a mixture of polymers or may be made by sequential layering of water-soluble polymers and biodegradable polymers. In such case, the final water-dispersible hybrid sheet, e.g., water-dispersible hybrid sheet 100, may disintegrate into pieces or particles when placed into water or an aqueous solution. The pieces or particles that the water-dispersible hybrid sheet disintegrates into, may be of at least two forms, the first form comprising water-soluble particles and the second form comprising biodegradable particles. Some of the disintegrated pieces or particles, which comprise water-soluble polymers, will immediately dissolve in water, whereas other disintegrated pieces, which do not comprise water-soluble polymers but rather comprise biodegradable polymers, will disintegrate, though at a slower rate, to organic ingredients, thereby reducing and preferably avoiding the creation of microplastics.

According to some embodiments, the process by which the water-dispersible hybrid sheet, e.g., water-dispersible hybrid sheet 100, may be produced, may be a layering process or fabric 3D printing, similar to the one described in U.S. Pat. No. 9,731,319 by Tamicare Ltd., which is hereby incorporated by reference in its entirety. According to the present disclosure, the layering process disclosed in U.S. Pat. No. 9,731,319 may be implemented to layer water-soluble polymers and loose fibers, e.g., fibers 11, in order to create the water-dispersible hybrid sheets of the present disclosure.

In some embodiments, the water-dispersible hybrid sheet 100 may further comprise an addition of midway biodegradable, separate fibers 12. In some embodiments, the separate midway positioned fibers 12 may be positioned within the continuous water-soluble polymeric layer 10, in the same plane, so that substantially the entire length of the midway fibers 12 may be covered by the water-soluble polymeric layer 10, and little to no ends of midway fibers 12 may be protruding from the polymeric layer 10. In some embodiments, the midway fibers 12 may improve characteristics or properties of the water-dispersible hybrid sheet, e.g., strength, drape, feel, breathability and sweat management, or any combination thereof. In some embodiments, the length of midway fibers 12 may be in the range of 0.2 to 5 mm. In other embodiments, the length of midway fibers 12 may be in the range of 0.2 to 20 mm.

Reference is now made to FIG. 2, which schematically illustrates the water-dispersible hybrid sheet a short time after being exposed to water or to an aqueous solution, according to some embodiments of the present disclosure. According to some embodiments, the water-dispersible hybrid sheet illustrated in FIG. 2 comprises no midway fibers 12.

In some embodiments, at the end of life of a water-dispersible hybrid sheet, e.g., water-dispersible hybrid sheet 100, the water-dispersible hybrid sheet may be exposed to water or aqueous environment at predetermined conditions, such as environment temperature, which is typically around 15 to 65 degrees Celsius. During such exposure, the water that are near and are in contact with loose fibers 11, may weaken the connection between loose fibers 11 and water-soluble polymeric core 10, as the water-soluble polymeric core begins to dissolve due to water or aqueous presence. Accordingly, the short biodegradable loose fibers 11 may disconnect or separate themselves from the water-soluble polymeric core layer 10 before, or at the same time as the disintegration and dissolving process of the entire water-soluble polymeric layer 10. As illustrated in FIG. 2, fibers 11 begin to depart from polymeric core 10, such that some fibers are no longer embedded within polymeric core 10.

In some embodiments, the disintegration of the water-dispersible hybrid sheet may be accelerated by the un-even structure of the water-soluble polymeric layer 10. The un-even structure of the polymeric layer 10 may increase the surface area of the water-dispersible hybrid sheet, and its contact area with water, so that both the polymeric layer 10 and the biodegradable fibers 11 may disintegrate within a short time, e.g., from a few seconds to several hours, per design preference, when fully immersed in water. In some embodiments, the disintegration of the water-dispersible hybrid sheet may be without leaving any lumps of agglomerated fibers, and without creating any ropes or chains of fibers, which are likely to be trapped in water lines and drainpipes, and further without leaving any harmful residue in the water and/or the environment where disintegration is taking place. In some embodiments, when the water-dispersible hybrid sheet is exposed to water or aqueous environment, e.g., at predetermined conditions of, for example, temperature, the water-soluble polymeric core layer 10 may begin to dissolve and the connection between the loose fibers 11 and the water-soluble polymeric core layer 10 may weaken until each of the loose fibers 11 may separately disconnect from the water-soluble polymeric core layer 10, to prevent creation of fiber chains or fiber agglomeration, thereby avoiding clogging of, e.g., sewage pipelines.

In some embodiments, the short, biodegradable loose fibers 11 may be hydrophilic. Thus, once the water-dispersible hybrid sheet, such as water-dispersible hybrid sheet 100, is in contact with an aqueous environment or with water, hydrophilic loose fibers 11 may absorb moisture or water from the environment. Therefore, not only do the short hydrophilic loose fibers 11 quickly begin to detach from the water-soluble polymeric layer 10, but hydrophilic loose fibers 11 also promote the disintegration of the water-soluble polymeric layer 10 since they lead water into the water-soluble polymeric layer 10, at the currently empty places that fibers 11 were initially embedded within. That is, absence of loose fibers 11 along the water-dispersible hybrid sheet, during water contact, may quicken disintegration of the water-dispersible hybrid sheet.

In some embodiments, at least part of the biodegradable loose fibers 11 may be water-soluble fibers.

In some embodiments, the polymeric layer 10 may be a mixture of at least one biodegradable or composable polymer, for example, Natural Rubber Latex, and at least one water-soluble polymer, for example, Polyvinyl Alcohol.

In some embodiments, the biodegradable and/or water-soluble polymeric layer 10 may comprise a variety of additives to provide or improve the fabric drape, softness, elasticity, strength, aesthetics, hand-feel, smell, biodegradability or water dispersibility accelerators and/or decelerators or any other desired fabric performance.

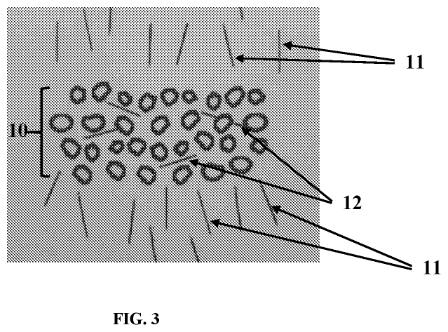

Reference is now made to FIG. 3, which is a schematic illustration of a water-dispersible hybrid sheet, at a late time after being exposed to water or to an aqueous solution, according to some embodiments of the present disclosure. According to some embodiments, some time after exposure of the water-dispersible hybrid sheet, e.g., water-dispersible hybrid sheet 100, to water or to an aqueous environment, fibers 11 have already departed from polymeric layer 10, and polymeric layer 10 begins to disintegrate and break into particles (schematically illustrated as closed circular shapes). In case water-dispersible hybrid sheet included midway fibers 12, as illustrated in FIG. 1, these midway fibers 12 also begin to depart from polymeric layer 10.

According to some embodiments, the water-soluble polymeric layer 10 may be designed to dissolve at a predefined range of water temperature, which may enable to disintegrate the water-dispersible hybrid sheet, e.g., water-dispersible hybrid sheet 100, in a washing machine, at a pre-set temperature.

In some embodiments, examples for water-soluble polymers that the polymeric layer 10 may comprise, may be Polyvinyl Alcohol (PVOH), e.g., Kuraray Poval™ (Poval 4-88, by Kuraray). Similar polymers with similar characteristics may be used in addition or alternatively to those mentioned.

In some embodiments, examples for biodegradable fibers 11 may comprise at least one of or any combination of: Rayon Viscose, Modal, Tencel, Cotton. Similar fibers with similar characteristics may be used in addition or alternatively to those mentioned.

In some embodiments, the water-dispersible hybrid sheet, e.g., water-dispersible hybrid sheet 100, may be used for making products such as, garments, undergarments, toilet paper, diapers, sanitary pads, wipes, masks, or any other desired product.

Conjugated terms such as, by way of example, ‘a thing property’ implies a property of the thing, unless otherwise clearly evident from the context thereof.

The flowchart and block diagrams illustrate architecture, functionality or an operation of possible implementations of systems, and methods according to various embodiments of the present disclosed subject matter. It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A water-dispersible hybrid sheet comprising:
a water-soluble polymer, and
short loose fibers.

2. The water-dispersible hybrid sheet according to claim 1, wherein the water-soluble polymer acts as a binding agent for the loose fibers to bind to, thereby creating a fabric layer, and further wherein when exposed to water or aqueous environment, the water-dispersible hybrid sheet disintegrates.

3. The water-dispersible hybrid sheet according to claim 1 or 2, wherein the water-soluble polymer disintegrates, in water or aqueous presence, into two main forms—water-soluble particles and biodegradable particles, without any microplastics.

4. The water-dispersible hybrid sheet according to claim 1, wherein the water-soluble polymer creates a water-soluble polymeric core layer having an upper side and a bottom side and further wherein the loose fibers are partly embedded into at least the upper side, the bottom side or both the upper and bottom sides of the water-soluble polymeric core layer.

5. The water-dispersible hybrid sheet according to claim 1, wherein when the water-dispersible hybrid sheet is exposed to water or aqueous environment, the water-soluble polymeric core layer begins to dissolve and the connection between the loose fibers and the water-soluble polymeric core layer weakens until each of the loose fibers separately disconnects from the water-soluble polymeric core layer, to prevent creation of fiber chains or fiber agglomeration, thereby avoiding clogging.

6. The water-dispersible hybrid sheet according to any one of the preceding claims, wherein the loose fibres are biodegradable fibers.

7. The water-dispersible hybrid sheet according to any one of the preceding claims, wherein the loose fibers are hydrophilic thereby detaching from the water-soluble polymeric core layer, and further wherein the hydrophilic loose fibers are configured to absorb moisture or water from the environment to promote disintegration of the water-soluble polymeric core layer by leading water into the water-soluble polymeric core layer, at currently empty locations that the fibers used to occupy when the fibers were embedded into the water-soluble polymeric core layer.

8. The water-dispersible hybrid sheet according to any one of claims 1-6, wherein the loose fibers are water-soluble.

9. The water-dispersible hybrid sheet according to any one of the preceding claims, wherein the water-soluble polymer comprises a mixture of at least one water-soluble polymer and at least one biodegradable polymer.

10. The water-dispersible hybrid sheet according to any one of the preceding claims, wherein thickness of the water-dispersible hybrid sheet is between 0.1 to 3 mm.

11. The water-dispersible hybrid sheet according to any one of the preceding claims, wherein length of the loose fibres is between 0.2 to 3 mm.

12. The water-dispersible hybrid sheet according to claim 4, further comprising midway biodegradable fibers.

13. The water-dispersible hybrid sheet according to claim 12, wherein substantially an entire length of the midway fibers is positioned within the water-soluble polymeric core layer.
